(19) United States
(12) Patent Application Publication
(10) Pub. No.: US 2008/0242501 A1
(43) Pub. Date: Oct. 2, 2008

(54) Lock-up clutch control unit

(75) Inventor: Kazutoshi Tsunekawa, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/078,346

(22) Filed: Mar. 28, 2008

(30) Foreign Application Priority Data
Mar. 28, 2007 (JP) 2007-083524

(51) Int. Cl. F16H 61/58

(52) U.S. Cl. 477/62

(57) ABSTRACT

Deterioration of drivability due to operation of lock-up clutch mechanism is prevented. When the lock-up operation zone of a lock-up clutch 26 provided in a torque converter 20 is switched from OFF-area to ON-area and to OFF-area again in a predetermined time, a lock-up clutch control unit 50 that controls the lock-up clutch 26 inhibits the lock-up clutch 26 from starting engagement operation. Also, when the lock-up operation zone of the lock-up clutch 26 is switched from OFF-area to ON-area immediately before a shift, the lock-up clutch control unit 50 inhibits the lock-up clutch 26 from starting the engagement operation.

### REFERENCE TO RELATED APPLICATION

This invention claims the benefit of the priority of Japanese Patent Application No. 2007-083524 filed on Mar. 28, 2007, the entire disclosure thereof being incorporated herein by reference thereto.

### FIELD OF THE INVENTION

The present invention relates to a lock-up clutch control unit for controlling a lock-up clutch mechanism that mechanically connects an input shaft and an output shaft of a torque converter.

### BACKGROUND ART

Among the conventional lock-up clutch control units, there is known a lock-up clutch control unit that comprises a lock-up clutch activation means which activates a lock-up clutch, a shifting operation detection means which detects shifting operation of a transmission, and a control means which, when performing a shifting operation, controls the lock-up clutch activation means to put the lock-up clutch into connection in accordance thereto on a detection signal from the shifting operation detection means (refer to Japanese Unexamined Patent Publication (Kokai) No. 2001-12599). It is disclosed that, according to the lock-up clutch control unit, clutch shock, which is generated when a friction clutch is brought into engagement after the shifting operation is completed, be prevented from occurring, and durability of clutch facings be increased.

[Patent document 1]JP Patent Kokai Publication 2001-12599-A

However, the conventional lock-up clutch control unit has such a problem that, in case the shift control operation is started during engagement operation of the lock-up clutch, when frictional engagement elements (clutch and brake) of an automatic transmission change the state thereof from engagement (ON-area) to non-engagement (OFF-area) at a timing when the lock-up clutch and a lock-up piston are brought into touch with each other (piston touch), release shock is generated since the lock-up clutch is released even when the engagement is in process. Also, as for the conventional lock-up clutch control unit, there is given no particular description in Patent document 1, about measures for avoiding simultaneous engagement of the frictional engagement elements and the lock-up clutch of the automatic transmission.

The conventional lock-up clutch control unit also has such a problem that, even when a wide lock-up ON-area is ensured in the settings of a lock-up operation area map, which is the basis for controlling the lock-up clutch mechanism, actual lock-up ON-area may become narrower during shift operation as it is inhibited to carry out pre-charging of supplying an oil chamber of a lock-up piston with a lock-up pressure corresponding to a control skip zone (loss stroke zone) which lies in transition where the lock-up clutch mechanism is switched from non-engagement to engagement, or other cause. For example, in such a situation as the lock-up clutch starts engagement operation so as to effect an engine brake but is released from engagement immediately thereafter while running on a down slope with the lock-up clutch off, temporary effect of the engine brake may be followed by a feeling of idle-running or skidding. When such a phenomenon occurs while the driver is lightly applying the foot brake, it affects the force required to apply the foot brake and the effect of deceleration. Therefore, not only the drivability (ease in driving, or maneuverability) is compromised, but also in the case of a large vehicle that can be effectively decelerated by the air brake during running with a load far below the rating, the brake may particularly become difficult to control.

Further, in the conventional lock-up clutch control unit, the pressure to be applied to the lock-up clutch is increased toward putting the lock-up clutch into engagement, even when it is about to carry out shift operation. When the lock-up clutch is controlled in such a way as described above during switching from a released state to an engagement state immediately before shifting, a change in the rotation speed of the torque converter turbine may adversely affect the shift control and cause a shift shock.

Furthermore, in the conventional lock-up clutch control unit, when the lock-up pressure is held at the same level from the beginning of a shift operation up to completion of the shift operation, the lock-up pressure may not necessarily be low but may be high depending on a control phase at the beginning of the shift control. As a result, various levels of shift shock may be caused.

Still further, in the conventional lock-up clutch control unit, when the lock-up pressure is held at a low level from the beginning of a shift operation up to completion of the shift operation, increasing the throttle opening during the shifting operation may cause the friction material of the lock-up clutch to wear.

Still further, the conventional lock-up clutch control unit has such a problem that, when the lock-up clutch is released from engagement in case a target lock-up pressure has been set to zero at the beginning of the shift control, an abrupt change in deceleration or acceleration may cause a feeling of unstable (fluctuated) acceleration or deceleration.

### SUMMARY OF THE DISCLOSURE

It is an object of the present invention to prevent the drivability from being adversely affected by the operation of the lock-up clutch mechanism.

According to a first aspect of the present invention, there is presented a lock-up clutch control unit for controlling a lock-up clutch mechanism provided in a torque converter, wherein the lock-up control unit inhibits the lock-up clutch mechanism from starting an engagement operation when a zone based on a lock-up operation area map relevant to the lock-up clutch mechanism is switched from OFF-area through ON-area and again to OFF-area within a predetermined period of time in accordance to the vehicle conditions.

According to a second aspect of the present invention, there is presented a lock-up clutch control unit for controlling a lock-up clutch mechanism provided in a torque converter, wherein the lock-up control unit inhibits the lock-up clutch mechanism from disengaging during the engagement operation, when the lock-up clutch mechanism is in the course of performing the engagement operation.

According to a third aspect of the present invention, there is presented a lock-up clutch control unit for controlling a lock-up clutch mechanism provided in a torque converter, wherein the lock-up clutch control unit carries out such a control action immediately after engagement has been established as to inhibit the lock-up clutch mechanism from disengaging during an engagement operation in case the engine speed and the input shaft speed of an automatic transmission are higher than a predetermined speed, even when a zone based on a lock-up operation area map relevant to the lock-up clutch mechanism is switched from ON-area to OFF-area in accordance to the vehicle conditions.

According to a fourth aspect of the present invention, there is presented a lock-up clutch control unit for controlling a lock-up clutch mechanism provided in a torque converter, wherein the lock-up control unit inhibits the lock-up clutch mechanism from engaging regardless of which zone is selected according to the lock-up operation area map relevant to the lock-up clutch mechanism and regardless of whether the lock-up clutch mechanism is engaged or not, when the engine speed and the input shaft speed of the automatic transmission are lower than a predetermined speed.

According to a fifth aspect of the present invention, there is presented a lock-up clutch control unit for controlling a lock-up clutch mechanism provided in a torque converter, wherein the lock-up control unit inhibits the lock-up clutch mechanism from starting an engagement operation, when a zone based on a lock-up operation area map relevant to a lock-up clutch mechanism is switched from OFF-area to ON-area in accordance to the vehicle conditions immediately before shifting.

According to a sixth aspect of the present invention, there is presented a lock-up clutch control unit for controlling a lock-up clutch mechanism provided in a torque converter, wherein the lock-up control unit inhibits the lock-up clutch mechanism from starting an engagement operation, when a shifting operation starts immediately after the zone based on a lock-up operation area map relevant to the lock-up clutch mechanism is switched from OFF-area to ON-area, in accordance with the vehicle conditions.

According to a seventh aspect of the present invention, there is presented a lock-up clutch control unit for controlling a lock-up clutch mechanism provided in a torque converter, wherein at least two of the controls of the first through sixth aspects can be additionally carried out in various combined fashions.

The meritorious effects of the various aspects of the present invention are summarized as follows, however, without limitation thereto.

According to the first aspect of the present invention, when the zone may be switched to OFF-area during an engagement operation, the lock-up clutch mechanism is inhibited from starting the engagement operation, so that there is no chance of the lock-up clutch mechanism disengaging during the engagement operation thereby preventing the drivability from deteriorating due to the fluctuation of the output torque.

According to the second aspect of the present invention, at a point when the lock-up clutch comes into piston touch (starting partial connection of the clutch) during an engagement operation, the lock-up clutch is inhibited from releasing while the output torque is being fluctuating, so that output torque is suppressed from fluctuating and drivability is prevented from deteriorating.

According to the third aspect of present invention, in the case that the zone switches to OFF-area immediately after the engagement, when the Ne and Nt exceed a predetermined revolution speed, the lock-up clutch is inhibited from releasing, so that output torque is suppressed from fluctuating and drivability is prevented from deteriorating.

According to the fourth aspect of present invention, when the Ne and Nt are lower than a predetermined revolution speed, the lock-up clutch is inhibited from engaging irrespective of the lock-up operation zone and engagement state of the lock-up clutch, so that the engine is prevented from stalling.

According to the fifth aspect of present invention, when the lock-up operation zone is switched from OFF-area to ON-area immediately before shift operation, the lock-up clutch is inhibited from starting engagement operation, so that fluctuation of shift shock due to the variation in the indicated lock-up pressure is prevented. Also, since the lock-up clutch is prevented from slipping during a shifting operation, durability of the friction material is improved. Moreover, since the lock-up clutch is prevented from disengaging immediately after the engagement, drivability is prevented from deteriorating due to the fluctuation of the output torque.

According to the sixth aspect to the present invention, since the lock-up clutch is inhibited from starting the engagement operation in case the next shift control starts during an engagement operation of the lock-up clutch and the lock-up operation zone is switched to OFF-area simultaneously with the start of the shift operation, there is no chance of the lock-up clutch being released from engagement. Therefore, booming noises or vibrations are not generated during shifting and the transmission is prevented from simultaneous engagement with frictional engagement elements.

According to the seventh aspect, at least two of the effects for the first through sixth aspects can be realized in various combinations upon needs.

### BRIEF DESCRIPTION OF THE DRAWINGS

FIG. 1 is a schematic diagram which schematically illustrates a configuration of a vehicle including a lock-up clutch control unit according to an exemplary embodiment 1 of the present invention.

FIG. 2 is a sectional view which schematically illustrates a structure of a lock-up clutch mechanism.

FIG. 3 is a flow chart which schematically illustrates the operation of the lock-up clutch control unit according to the exemplary embodiment 1 of the present invention.

FIG. 4 is a flow chart which schematically illustrates a lock-up area shift busy determination operation of the lock-up clutch control unit according to the exemplary embodiment 1 of the present invention.

FIG. 5 is a sequence chart which schematically illustrates an example of the operation of the lock-up clutch control unit according to the exemplary embodiment 1 of the present invention (case 1).

FIG. 6 is a sequence chart which schematically illustrates an example of the operation of the lock-up clutch control unit according to the exemplary embodiment 1 of the present invention (case 2).

FIG. 7 is a sequence chart which schematically illustrates an example of the operation of the lock-up clutch control unit according to the exemplary embodiment 1 of the present invention (case 3).

FIG. 8 is a sequence chart which schematically illustrates an example of the operation of the lock-up clutch control unit according to the exemplary embodiment 1 of the present invention (case 4).

FIG. 9 is a sequence chart which schematically illustrates an example of the operation of the lock-up clutch control unit according to the exemplary embodiment 1 of the present invention (case 5).

### BRIEF DESCRIPTION OF REFERENCE NUMERALS

10: Power plant (engine)
11: Throttle pedal
12: Rotary shaft
13: Coupling member
13a: Clutch counterpiece
20: Torque converter
21: Pump impeller
22: Turbine impeller
23: One-way clutch
24: Housing
25: Stator impeller
26: Lock-up clutch
27: Drive plate
28a: First driven plate
28b: Second driven plate
29: Lock-up piston
30: Automatic transmission
31: Input shaft
32: Output shaft
40: Hydraulic control circuit
41: First solenoid valve
42: Second solenoid valve
43: Third solenoid valve
50: Electronic control unit (lock-up clutch control unit)
51: CPU
52: ROM
53: RAM
54, 55: Interface
61: Acceleration stroke sensor
62: Engine speed sensor
63: Input shaft speed sensor
64: Output shaft speed sensor
65: Shift position sensor
R: Rivet
S: Coil spring
R1: Engagement-side oil chamber
R2: Release-side oil chamber

### PREFERRED MODES FOR CARRYING OUT THE INVENTION

### Exemplary Embodiment 1

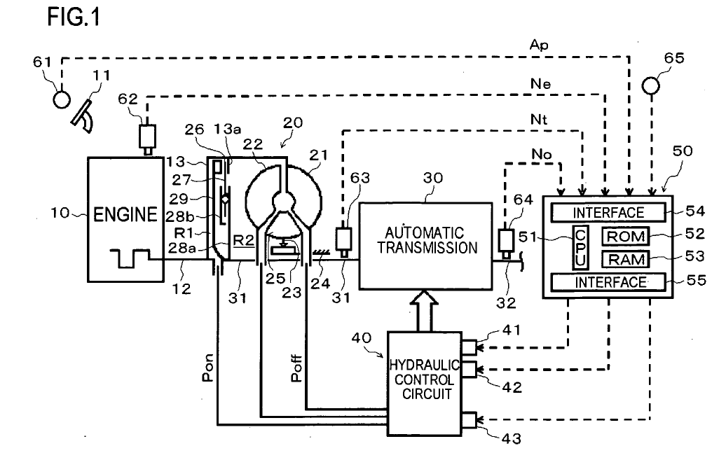

A lock-up clutch control unit according to an exemplary embodiment 1 of the present invention will be described with reference to the drawings. FIG. 1 is a schematic diagram schematically illustrating constitution of a vehicle including the lock-up clutch control unit according to the exemplary embodiment 1 of the present invention.

Referring to FIG. 1, the vehicle includes an engine 10, a torque converter 20, an automatic transmission 30, a hydraulic control circuit 40 and an electronic control unit 50.

The engine 10 may be an (combustion) engine, a motor, a hybrid engine or the like. The output power from the engine 10 is increased or decreased by an operation of a throttle pedal 11, transmitted to a torque converter 20, an automatic transmission 30, and further transmitted to driving wheels (not shown) via differential gears (not shown).

The torque converter 20 includes, generally speaking, a fluid transmission mechanism and a lock-up clutch mechanism. The fluid transmission mechanism includes a pump impeller 21, a turbine impeller 22 and a stator impeller 25. The pump impeller 21 is coupled to a rotary shaft 12 of the engine 10 via a coupling member 13 including a front cover and the like of the torque converter 20. The turbine impeller 22 is fixed to an input shaft 31 of the automatic transmission 30 and is driven to rotate by an oil pressure from the pump impeller 21. The stator impeller 25 is fixed to a housing 24 via a one-way clutch 23. The lock-up clutch mechanism is coupled to the fluid transmission mechanism in parallel. The lock-up clutch mechanism will be described later in detail.

The automatic transmission 30 includes the input shaft 31 and an output shaft 32 and provides a plurality of shift steps corresponding to the combination of engagement/disengagement among plural frictional engagement elements. The output shaft 32 is coupled to the driving wheels (not shown) via the differential gears (not shown).

The hydraulic control circuit 40 controls oil pressure provided to the automatic transmission 30 and the lock-up clutch mechanism. The hydraulic control circuit 40 includes a first solenoid valve 41, a second solenoid valve 42 and a third solenoid valve 43, each of which is driven to turn ON/OFF with a signal from the electronic control unit 50. The first solenoid valve 41 and the second solenoid valve 42 selectively control the frictional engagement elements in the automatic transmission 30 to engage or release (disengage) with a predetermined pressure. The third solenoid valve 43 controls the oil pressure Pon and Poff provided to an engagement-side oil chamber R1 or a release-side oil chamber R2 to control engagement or release (disengagement) of a lock-up clutch 26. As for the third solenoid valve 43, for example, a solenoid-driven valve, in which the ratio between ON-time and OFF-time (duty ratio) is controlled by a signal from the electronic control unit 50, may be employed. The third solenoid valve 43 controls line pressure via a lock-up pressure control valve to provide a control oil pressure to the engagement-side oil chamber R1. Also, the third solenoid valve 43 provides a constant pressure from the hydraulic control circuit 40 to a release-side oil chamber R2 under a duty control; and under non-duty control, provides a drain pressure from the hydraulic control circuit 40 to the release-side oil chamber R2 to adjust the engagement pressure of the lock-up clutch 26.

The electronic control unit 50 is electrically connected to an acceleration stroke sensor 61, an engine speed sensor 62, an input shaft speed sensor 63, an output shaft speed sensor 64, and a shift position sensor 65. The acceleration stroke sensor 61 detects throttle opening Ap of the throttle pedal 11. The engine speed sensor 62 detects revolution speed Ne of the engine 10. The input shaft speed sensor 63 detects revolution speed Nt of the input shaft 31 of the automatic transmission 30. The output shaft speed sensor 64 detects revolution speed No of the output shaft 32 of the automatic transmission 30. The shift position sensor 65 detects shift position such as L-range and R-range. The electronic control unit 50 receives, via an interface 54, a signal representing the throttle opening Ap, a signal representing engine revolution speed Ne (equivalent to revolution speed of the pump impeller 21), a signal representing input shaft revolution speed Nt (equivalent to revolution speed of the turbine impeller 22), a signal representing output shaft revolution speed No, and a signal representing the shift position.

The electronic control unit 50 includes a CPU 51, a ROM 52, a RAM 53 and interfaces 54 and 55.

The CPU 51 detects vehicle conditions (throttle opening, vehicle speed, engine revolution speed, output shaft revolution speed, input shaft revolution speed, engine torque, shift position and the like) based on detection signals from various sensors and control signals of various actuators (including solenoid valves). In accordance with the vehicle conditions based on the detection signals from various sensors, the CPU 51 appropriately utilizes the RAM 53 based on programs and data base (map) stored in the ROM 52, and sends control signals to control the drive of the first to third solenoid valves 41, 42 and 43 via the interface 55 to thereby control the shift of the automatic transmission 30 and engagement of the lock-up clutch 26. The ROM 52 stores a back pressure map, a lock-up operation area map of the lock-up clutch mechanism, and other map for obtaining transmission capacity (a lock-up pressure map during shifting, lock-up pressure map at start of slip control). The electronic control unit 50 is the lock-up clutch control unit. In the lock-up clutch operation area map here, shift steps of the automatic transmission of a vehicle, vehicle speed and throttle opening and the like are previously determined as parameters, and it is prescribed so that when the lock-up clutch is positively turned ON on the vehicle, the engine brake can be utilized. Therefore, the vehicle conditions frequently switch between ON-area and OFF-area on the lock-up clutch operation area map.

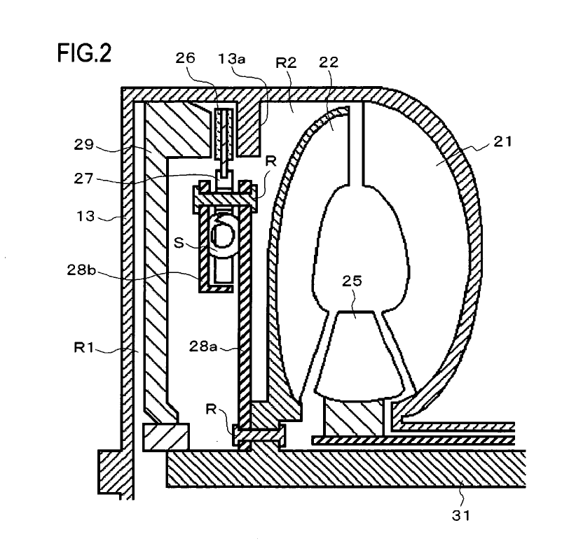

Next, a configuration of the lock-up clutch mechanism will be described. FIG. 2 is a sectional view schematically illustrating structure of the lock-up clutch mechanism.

Referring to FIG. 2, the lock-up clutch mechanism includes a lock-up clutch 26, a drive plate 27, a clutch counterpiece 13a, a first driven plate 28a, a second driven plate 28b, a lock-up piston 29 and a coil spring S.

The lock-up clutch 26 is a ring-like plate provided with a friction material at both sides and is movably held in an axial direction. The drive plate 27 is a ring-like plate fixed to the inner side of the lock-up clutch 26 in a diametrical direction thereof and is disposed movably in an axial direction between the first driven plate 28a and the second driven plate 28b. The clutch counterpiece 13a is a portion arranged integrally with the coupling member 13 to be opposed to one face of the lock-up clutch 26. The first driven plate 28a is a plate fixed with rivets to the input shaft 31 of the automatic transmission (30 in FIG. 1) so as to rotate integrally with the input shaft 31. The second driven plate 28b is a ring-like plate fixed to the first driven plate 28a with a rivet R. The coil spring S is an absorber mechanism for absorbing vibrations among the first driven plate 28a, the second driven plate 28b and the drive plate 27. The coil spring S is received within a window portion formed in an appropriate portion along a circumferential direction of the first and second driven plates 28a and 28b. When a torsion angle is generated between the drive plate 27 (lock-up clutch 26) and the first driven plate 28a (second driven plate 28b), the coil spring S imparts an elastic force between the drive plate 27 and the first driven plate 28a.

The lock-up piston 29 is a ring-like (annular) piston for pressurizing the lock-up clutch 26 to the clutch counterpiece 13a and is arranged to be movable in an axial direction thereof with the oil pressure in the engagement-side oil chamber R1. When the oil pressure within the engagement-side oil chamber R1 defined by the lock-up piston 29 and the coupling member 13 is increased to be higher than the oil pressure within the release-side oil chamber R2 defined by the lock-up clutch 26, the clutch counterpiece 13a and the first driven plate 28a, the lock-up piston 29 pressurizes the lock-up clutch 26 toward the clutch counterpiece 13a to engage the lock-up clutch 26 with the clutch counterpiece 13a. Contrarily, when the oil pressure within the release-side oil chamber R2 is increased to be higher than that within the engagement-side oil chamber R1, the lock-up piston 29 separates the lock-up clutch 26 away from the clutch counterpiece 13a to disengage the lock-up clutch 26 from the clutch counterpiece 13a.

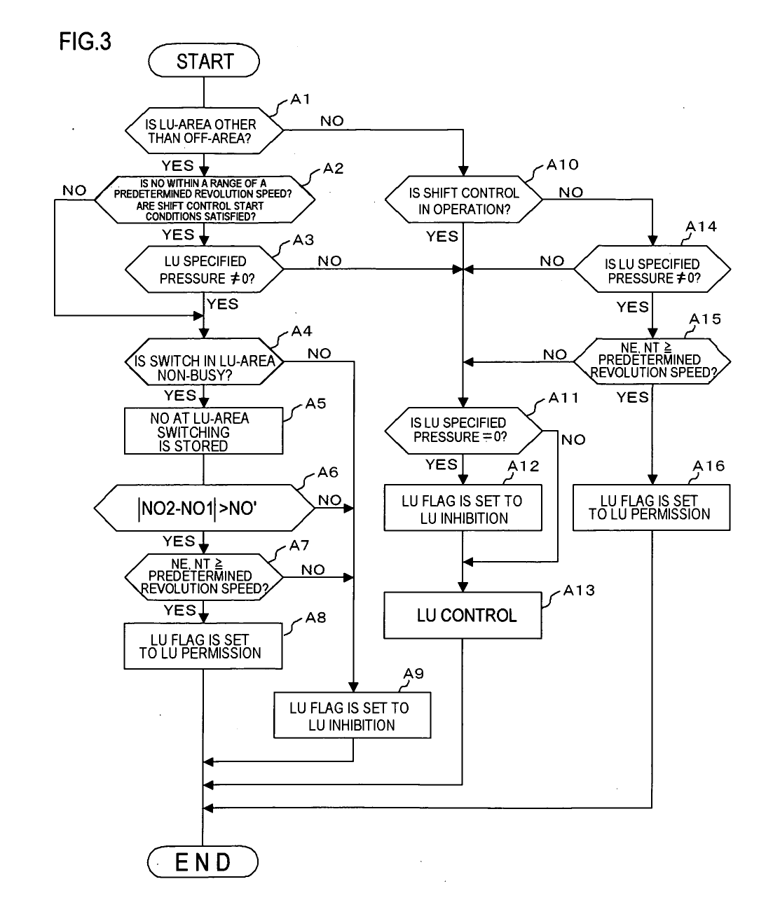

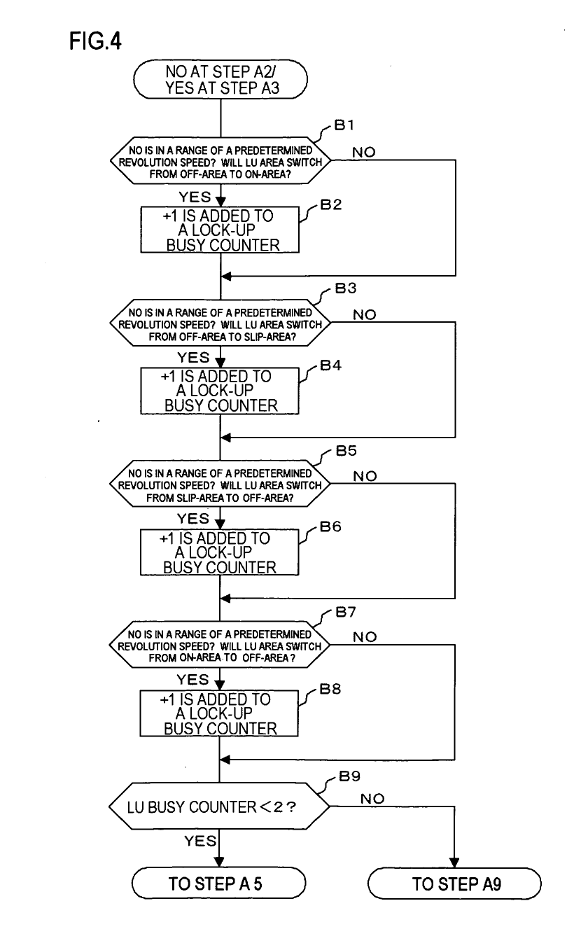

Next, an operation of the lock-up clutch control unit according to the exemplary embodiment 1 of the present invention will be described with reference to drawings. FIG. 3 is a flow chart schematically illustrating the operation of the lock-up clutch control unit according to the exemplary embodiment 1 of the present invention. FIG. 4 is a flow chart schematically illustrating determination operation of lock-up area shift busy in the lock-up clutch control unit according to the exemplary embodiment 1 of the present invention.

Initially, the electronic control unit (50 in FIG. 1) determines whether the lock-up area (LU-area) based on lock-up operation area map (LU-area map) and detection signals from various sensors is other than OFF-area (step A1). If the LU-area is not other than OFF-area (NO at step A1), the process proceeds to step A10.

When the LU-area is other than OFF-area (YES at step A1), the electronic control unit (50 in FIG. 1) determines whether the output shaft revolution speed No of the automatic transmission (30 in FIG. 1) is within a range of a predetermined revolution speed and whether shift control start conditions are satisfied based on a shift control map and detection signals from various sensors (step A2). Here, shift control start conditions mean conditions for starting the shift control. For example, it is determined whether the shift control-start conditions are satisfied by determining if the shift position is switched, or whether the vehicle speed reaches a predetermined speed during automatic shift controlling etc. When the shift control start conditions are not satisfied (NO at step A2), the process proceeds to step A4.

When the conditions are satisfied (YES at step A2), the electronic control unit (50 in FIG. 1) determines whether lock-up specified pressure (LU specified pressure) based on the lock-up pressure map and the detection signals from various sensors is other than 0 (step A3). When the LU specified pressure is not other than 0 (NO at step A3), the process proceeds to step A11.

When the LU specified pressure is other than 0 (YES at step A3), or when the shift control start conditions are not satisfied (NO at step A2), the electronic control unit (50 in FIG. 1) determines if the switch in the LU-area is non-busy (plural switches do not exist in a predetermined time) (step A4). When the switch is non-busy (YES step at A4), the process proceeds to step A5. When the switch is not non-busy (NO at step A4), the process proceeds to step A9.

The determination at step A4 whether the switch of the LU-area is non-busy is carried out as described below.

When the LU specified pressure is other than 0 (YES at step A3), or when the shift control start conditions are not satisfied (NO at step A2), the electronic control unit (50 in FIG. 1) determines whether the output shaft revolution speed No of the automatic transmission (30 in FIG. 1) is in a range of a predetermined revolution speed and whether the lock-up area will switch from OFF-area to ON-area in a predetermined time (step B1). When the lock-up area will not switch from OFF-area to ON-area (NO at step B1), the process proceeds to step B3.

When the lock-up area will switch from OFF-area to ON-area (YES at step B1), the electronic control unit (50 in FIG. 1) adds +1 to a lock-up busy counter (step B2). The lock-up busy counter here is a counting unit that counts number of times of switches in a predetermined time.

After step B2 or when the lock-up area will not switch from OFF-area to ON-area (NO at step B1), the electronic control unit (50 in FIG. 1) determines whether the output shaft revolution speed No of the automatic transmission (30 in FIG. 1) is in a range of a predetermined revolution speed and whether the lock-up area will switch from OFF-area to SLIP-area in a predetermined time (step B3). When the lock-up area will not switch from OFF-area to SLIP-area (NO in step B3), the process proceeds to step B5.

When the lock-up area will switch from OFF-area to SLIP-area (YES at step B3), the electronic control unit (50 in FIG. 1) adds +1 to the lock-up busy counter (step B4).

After step B4 or when the lock-up area will not switch from OFF-area to SLIP-area (NO in step B3), the electronic control unit (50 in FIG. 1) determines whether the output shaft revolution speed No of the automatic transmission (30 in FIG. 1) is in a range of a predetermined revolution speed and whether the lock-up area will switch from SLIP-area to OFF-area in a predetermined time (step B5). When the lock-up area will not switch from SLIP-area to OFF-area (NO at step B5), the process proceeds to step B7.

When the lock-up area will switch from SLIP-area to OFF-area (YES at step B5), the electronic control unit (50 in FIG. 1) adds +1 to the lock-up busy counter (step B6).

After step B6 or when the lock-up area will not switch from SLIP-area to OFF-area (NO at step B5), the electronic control unit (50 in FIG. 1) determines whether the output shaft revolution speed No of the automatic transmission (30 in FIG. 1) is in a range of a predetermined revolution speed and whether the lock-up area will switch from ON-area to OFF-area in a predetermined time (step B7). When the lock-up area will not switch from ON-area to OFF-area (NO at step B7), the process proceeds to step B9.

When the lock-up area will switch from ON-area to OFF-area (YES at step B7), the electronic control unit (50 in FIG. 1) adds +1 to the lock-up busy counter (step B8).

After step B8 or when the lock-up area will not switch from ON-area to OFF-area (NO in step B7), the electronic control unit (50 in FIG. 1) determines whether the number of the lock-up busy counter is smaller than 2 (step B9). When the number is smaller than 2 (YES at step B9), the electronic control unit determines that the switch is non-busy, the process proceeds to step A5. When the number is not smaller than 2 (NO at step B9), the electronic control unit determines that the switch is not non-busy (busy), the process proceeds to step A9.

When the switch is non-busy (YES at step A4; YES at step B9), the electronic control unit (50 in FIG. 1) stores the output shaft revolution speed No of the automatic transmission (30 in FIG. 1) at switching to LU-area (step A5).

After step A5, the electronic control unit (50 in FIG. 1) determines whether an absolute value of a difference |No2-No| between the previous output shaft revolution speed No1 and the current output shaft revolution speed No2 is larger than a predetermined value No′ (step A6). As for the previous output shaft revolution speed No, a value stored in the adjacent cycle is used. As for the current output shaft revolution speed No, a value stored at the step A5 of the current cycle is used. When the absolute value is not larger than the predetermined value No′ (NO at step A6), the process proceeds to step A9.

When the absolute value is larger than the predetermined value No′ (YES at step A6), the electronic control unit (50 in FIG. 1) determines whether each of the engine revolution speed Ne and the input shaft revolution speed Nt exceeds a predetermined revolution speed (step A7). When the absolute value is not larger than the predetermined value No′ (NO at step A7), the process proceeds to step A9.

When the absolute value is larger than the predetermined value No′ (YES at step A7), the electronic control unit (50 in FIG. 1) sets a lock-up flag (LU flag) to lock-up permission (LU permission) (step A8), and terminates the process.

When the switch is not non-busy (NO at step A4, NO at step B9); when the value is not larger than the predetermined value No′ (NO at step A6); or when the speeds do not exceed a predetermined revolution speed (NO at step A7), the electronic control unit (50 in FIG. 1) sets the LU flag to lock-up inhibition (LU inhibition) (step A9), and terminates the process.

When the lock-up area is not other than OFF-area (NO at step A1), the electronic control unit (50 in FIG. 1) determines whether the shift control is in operation (step A10). When the shift control is not in operation (NO in step A10), the process proceeds to step A14.

When the LU specified pressure is not other than 0 (NO step A3); when the shift control in operation (YES at step A10); when the LU specified pressure is not other than 0 (NO at step A14); or when the speeds do not exceed a predetermined revolution speed (NO at step A15), the electronic control unit (50 in FIG. 1) determines whether the LU specified pressure is 0 (step A11). When the LU specified pressure is not 0 (NO at step A11), the process proceeds to step A13.

When the LU specified pressure is 0 (YES at step A11), the electronic control unit (50 in FIG. 1) sets the LU flag to lock-up inhibition (LU inhibition) (step A12).

After step A12 and when the LU specified pressure is not 0 (NO at step A11), the electronic control unit (50 in FIG. 1) controls the lock-up clutch (step A13), and terminates the process.

When the shift control is not in operation (NO at step A10), the electronic control unit (50 in FIG. 1) determines whether the lock-up specified pressure (LU specified pressure) based on the lock-up pressure map and detection signals from various sensors is other than 0 (step A14). When the LU specified pressure is not other than 0 (NO step A14), the process proceeds to step A11.

When the LU specified pressure is other than 0 (YES at step A14), the electronic control unit (50 in FIG. 1) determines whether each of the engine revolution speed Ne and the input shaft revolution speed Nt exceed a predetermined revolution speed (step A15). When the speeds do not exceed the predetermined revolution speed (NO at step A15), the process proceeds to step A11.

When the speeds exceeds the predetermined revolution speed (YES at step A15), the electronic control unit (50 in FIG. 1) sets the LU flag to lock-up permission (LU permission) (step A16) and terminates the process.

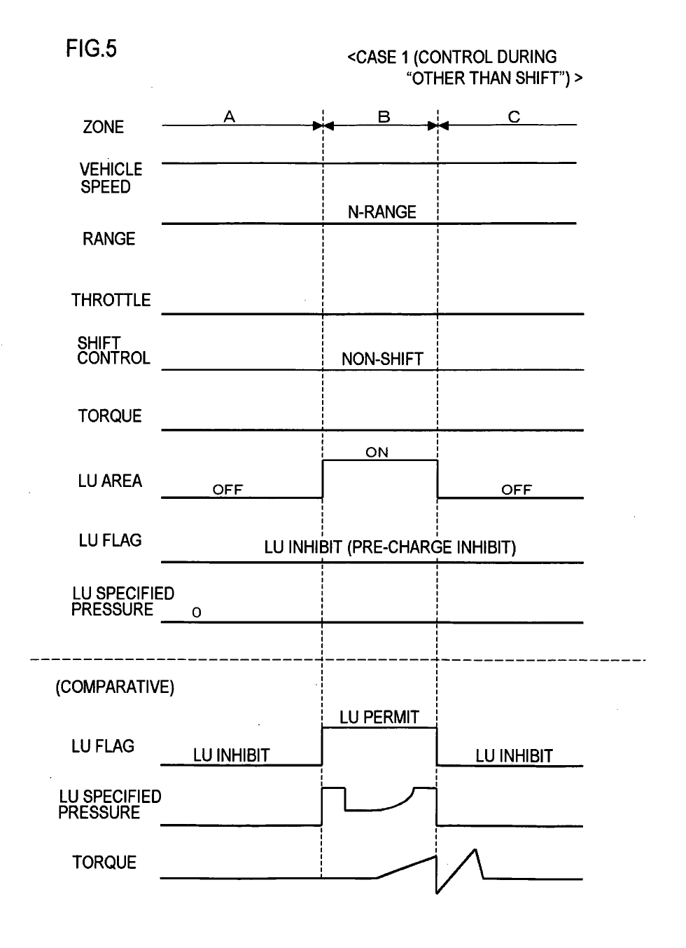

Next, examples of the operation of the lock-up clutch control unit according to the exemplary embodiment 1 of the present invention will be described. FIG. 5 to FIG. 9 are sequence charts schematically illustrating an example of the operation of the lock-up clutch control unit according to the exemplary embodiment 1 of the present invention.

### (Case 1)

Initially, a description about a control during “other than shift” will be given. Case 1 relates to a lock-up control in which, when there is a possibility that LU-area may switch to OFF-area while performing engagement operation during “other than shift”, the lock-up clutch is controlled not to start the engagement operation.

In a zone “A” in FIG. 5, the lock-up area (LU-area) is OFF-area (NO at step A1); the shift control is non-shift (for example, N-range) (NO at step A10); and the LU specified pressure is 0 (NO at step A14, YES at step A11). Therefore, the LU flag is set to LU inhibition (step A12) and thus the lock-up control is performed under a state of LU inhibition (step A13). The control in a zone “C” in FIG. 5 is the same as that in zone A.

In a zone “B” in FIG. 5, the lock-up area (LU-area) is ON-area (YES at step A1); the shift control is non-shift (for example, N-range) and the shift control start conditions are not satisfied (NO in step A2); and the LU-area switches plural times (twice) and is not non-busy (busy) (NO at step A4). Therefore, the LU flag is set to LU inhibition (step A9), the LU specified pressure remains 0, and the torque does not change; thus the drivability is not reduced. Contrarily, in a comparative case based on the related art, the LU flag is set to LU permission. Therefore, the LU specified pressure is controlled to change and the lock-up is released substantially at the same time as a piston touch of the lock-up clutch due to a pre-charge operation; and thus the torque changes greatly resulting in a reduced drivability.

### (Case 2)

A description of a control during manual shifting operation will now be given. Case 2 relates to a lock-up control in which, when there is a possibility that the LU-area switches to OFF-area while performing engagement operation during manual shift, the lock-up clutch is controlled not to start the engagement operation.

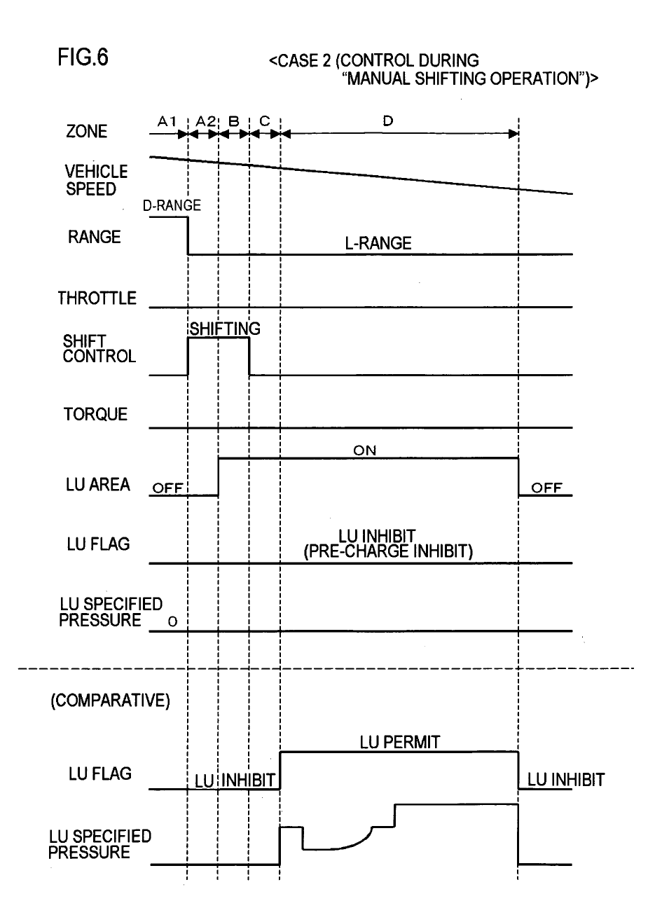

In a zone “A1” in FIG. 6, the LU-area is OFF-area (NO at step Al); in D-range, the shift control is non-shift (NO at step A10); and the LU specified pressure is 0 (NO at step A14, YES at step A11). Therefore, the LU flag is set to LU inhibition (step A12), and the lock-up control is performed under a state of LU inhibition (step A13).

In a zone “A2” in FIG. 6, the LU-area is OFF-area (NO at step Al); D-range switches to L-range, and the shift control is in shifting (YES at step A10); and the LU specified pressure is 0 (YES at step A11). Therefore, the LU flag is set to LU inhibition (step A12), and the lock-up control is preformed under a state of LU inhibition (step A13).

In a zone “B” in FIG. 6, the LU-area is ON-area (YES at step A1); D-range switched to L-range, and the shift control start conditions are satisfied (YES at step A2); and the LU specified pressure is 0 (NO at step A3, YES at step A11). Therefore, the LU flag is set to LU inhibition (step A12), and the lock-up control is performed under a state of LU inhibition (step A13). In zone C in FIG. 6, the control is the same as that in zone B.

In a zone “D” in FIG. 6, the LU-area is ON-area (YES at step A1); L-range is maintained and the shift control start conditions are not satisfied (NO at step A2); and the LU-area switches plural times (twice) and is not non-busy (busy) (NO at step A4). Therefore, the LU flag is set to LU inhibition (step A9), and the LU specified pressure is maintained 0, torque does not change, and thus the drivability is not reduced. That is, even when LU-area has switched to ON-area, when LU-area switches to OFF-area soon, the lock-up is inhibited (pre-charge inhibition). Contrarily, in a comparative case based on the related art, since the LU flag is set to LU permission and the LU specified pressure is controlled to change, the lock-up is released immediately after the pre-charge has started and the lock-up clutch has engaged. Thus, the torque change is increased and the drivability is reduced.

### (Case 3)

A description about a control during shifting operation will be given. Case 3 relates to a lock-up control in which, even when the LU-area switches from ON-area to OFF-area, when Ne and Nt rotate exceeding a predetermined speed, the lock-up clutch is controlled not to release the engagement immediately after the engagement.

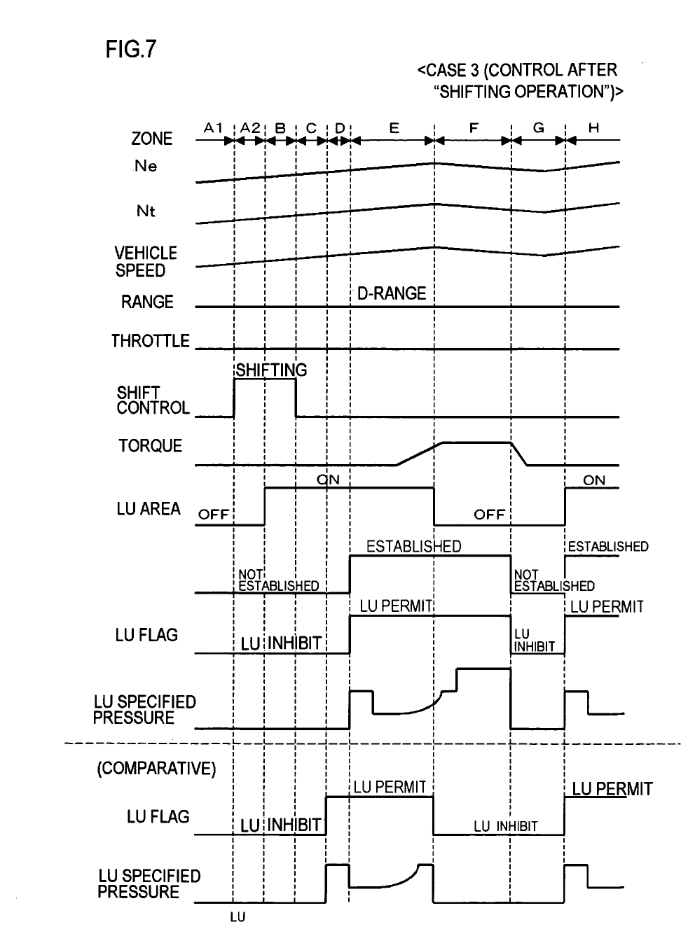

In a zone “A1” in FIG. 7, the LU-area is OFF-area (NO at step A1); in D-range, the shift control is non-shift (NO at step A10); and the LU specified pressure is 0 (NO at step A14, YES at step A11). Therefore, the LU flag is set to LU inhibition (step A12), and the lock-up control is performed under a state of LU inhibition (step A13).

In a zone “A2” in FIG. 7, the LU-area is OFF-area (NO at step Al); in D-range, the shift control is in shifting (YES at step A10); and the LU specified pressure is 0 (YES at step A11). Therefore, the LU flag is set to LU inhibition (step A12), and the lock-up control is performed under a state of LU inhibition (step A13).

In a zone “B” in FIG. 7, the LU-area is ON-area (YES at step A1); in D-range, the revolution speeds of Nt and Ne are increased and the shift control start conditions are satisfied (YES at step A2); and the LU specified pressure is 0 (NO at step A3, YES at step A11). Therefore, the LU flag is set to LU inhibition (step A12), and the lock-up control is performed under a state of LU inhibition (step A13). In a zone C and a zone D in FIG. 7 also, the control is the same as that in zone B. Contrarily, in a comparative case based on the related art, in a zone “D” in FIG. 7, since the LU-area switches from OFF-area to ON-area, even when Nt and Ne are less than specified revolution speed, the LU flag is set to LU permission. Therefore, since the LU specified pressure starts pre-charge, engine stall may occur due to insufficient revolution speed of Nt and Ne.

In a zone “E” in FIG. 7, the LU-area is ON-area (YES at step A1); in D-range, the revolution speed of Nt and Ne increase and the shift control start conditions are satisfied (YES at step A2); the LU specified pressure is other than 0 (YES at step A3); the LU-area switches 0 times and is non-busy (YES at step A4); due to increase of revolution speeds of Nt and Ne, No also increases, the absolute value of a difference between the previous and current Nos exceed a predetermined value (YES at step A6); and Nt and Ne exceed a predetermined revolution speed and rotation speed is determined to be satisfied (YES at step A7). Therefore, the LU flag is set to LU permission (step A8) and the LU specified pressure performs a pre-charge operation.

In a zone “F” in FIG. 7, the LU-area is OFF-area (NO at step A1); in D-range, the shift control is not in shifting (NO at step A10); the LU specified pressure is in engagement operation and is not 0 (YES at step A14); and Nt and Ne exceed a predetermined revolution speed, and rotation speed is determined to be satisfied (YES at step A15). Therefore, the LU flag is set to LU permission (step A16), the LU specified pressure performs an operation from pre-charge to engagement completion. Contrarily, in a comparative case based on the related art, since the LU-area switches from ON-area to OFF-area, the LU flag is set to LU inhibition and the LU specified pressure is 0. Therefore, the lock-up of the lock-up clutch is released immediately after engagement. Thus, the torque change is increased and the drivability is reduced.

In a zone “G” in FIG. 7, the LU-area is OFF-area (NO at step A1); in D-range, the shift control is not in shifting (NO at step A10); Nt, Ne are less than the predetermined revolution speed, and the LU specified pressure is 0 (NO at step A14, YES at step A11) to prevent engine stall. Therefore, the LU flag is set to LU inhibition (step A12), and lock-up control is performed under a state of LU inhibition (step A13).

In a zone “H” in FIG. 7, the LU-area is ON-area (YES at step A1); since immediately after the shift, the shift control start conditions are not satisfied (NO in step A2); since the LU-area switches once and is non-busy (YES at step A4); since the revolution speeds of Nt and Ne increase, No also increases and absolute value of difference between the previous and current values of No exceeds a predetermined value No′ (YES at step A6); and since Nt and Ne exceeds a predetermined revolution (YES at step A7), the rotation speed is determined as satisfied. Therefore, the LU flag is set to LU permission (step A8), and the LU specified pressure is controlled to perform pre-charge operation.

### (Case 4)

A description about a control immediately before shifting will now be given. Case 4 relates to a lock-up control in which, when the LU-area switches to ON-area immediately before shifting, the lock-up clutch is controlled not to lock up the engagement.

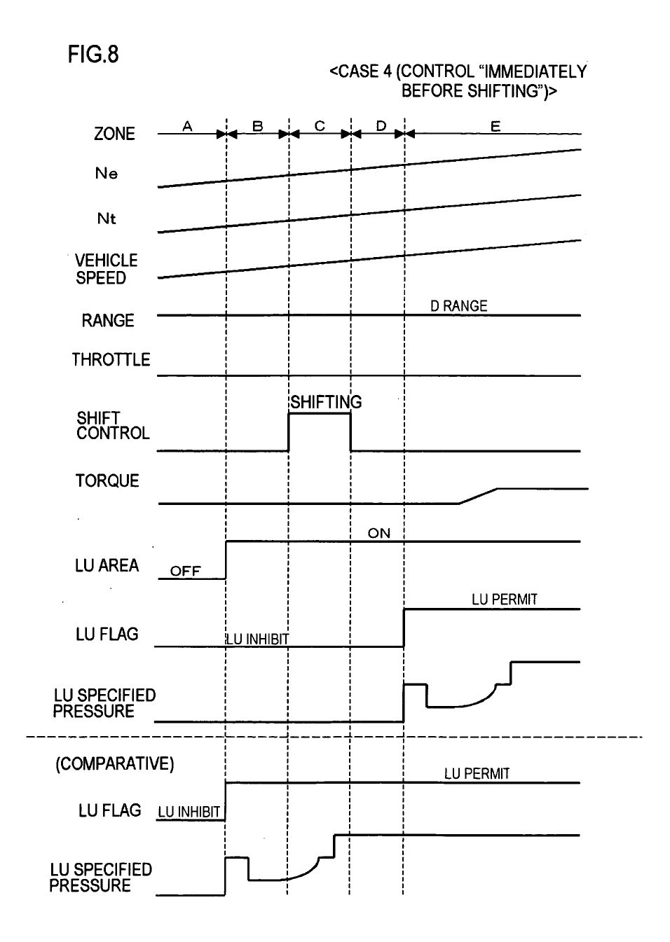

In a zone “A” in FIG. 8, the LU-area is OFF-area (NO at step A1); in D-range, the shift control is non-shift (NO at step A10); and the LU specified pressure is 0 (NO at step A14, YES at step A11). Therefore, the LU flag is set to LU inhibition (step A12), and the lock-up control is performed under a state of LU inhibition (step A13).

In a zone “B” in FIG. 8, the LU-area is ON-area (YES at step A1); in D-range, the revolution speeds of Nt and Ne increase and the shift control start conditions are satisfied (YES at step A2); and the LU specified pressure is 0 (NO at step A3, YES at step A11). Therefore, the LU flag is set to LU inhibition (step A12), and the lock-up control is performed under a state of LU inhibition (step A13). In a zone C and a zone D in FIG. 8 also, the control is the identical to that in the zone B. Contrarily, in a comparative case based on the related art, in the zones B to D in FIG. 8, since the LU-area switches from OFF-area to ON-area, the LU flag is set to LU permission. After the LU specified pressure has started the pre-charge operation, since shifting starts in the zone C, the lock-up clutch and the frictional engagement element in the transmission engage simultaneously. Therefore, the torque changes and the drivability is reduced.

In a zone “E” in FIG. 8, the LU-area is ON-area (YES at step A1); since immediately after the shift, the shift control start conditions are not satisfied (NO at step A2); the LU-area does not switch and is non-busy (YES in step A4); since the revolution speeds of Nt and Ne increase, No also increases and absolute value of the difference between the previous and current No values exceeds a predetermined value (YES at step A6); and since Nt and Ne exceed a predetermined revolution speed, the rotation speed is determined as satisfied (YES at step A7). Therefore, the LU flag is set to LU permission (step A8), and LU specified pressure performs pre-charge operation.

### (Case 5)

A description of a control of the case where shifting starts during lock-up engagement operation will now be given. Case 5 relates to a lock-up control in which shifting starts during lock-up engagement operation and when the LU-area switches to OFF-area, the lock-up clutch is controlled not to lock up the engagement.

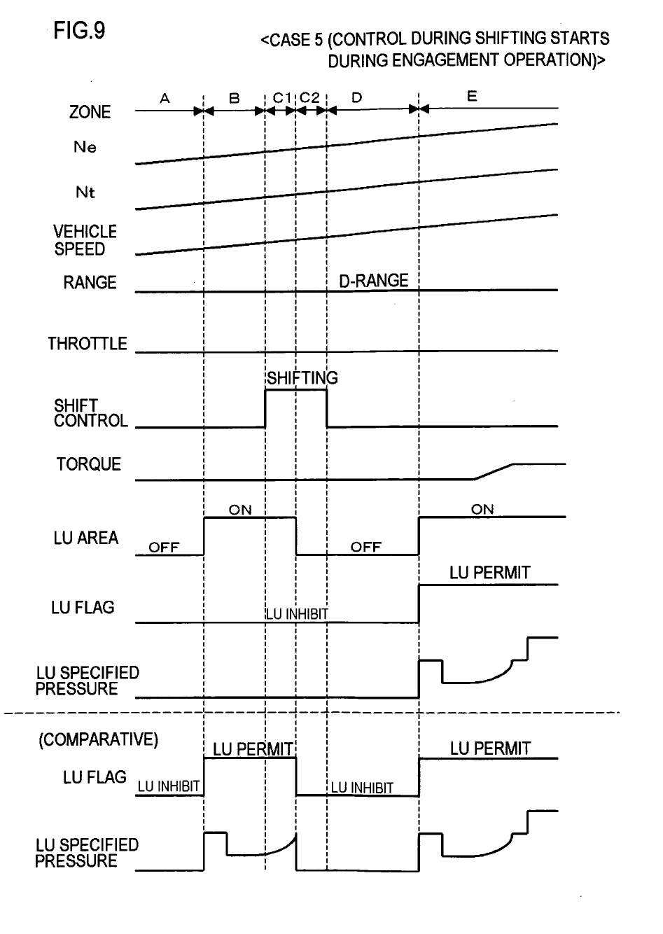

In a zone “A” in FIG. 9, the lock-up area (LU-area) is OFF-area (NO at step A1); in D-range, the shift control is non-shift (NO at step A10); and the LU specified pressure is 0 (NO at step A14, YES at step All). Therefore, the LU flag is set to LU inhibition (step A12), and the lock-up control is performed under a state of LU inhibition (step A13). In a zone “D” in FIG. 9, the control is the identical to that in zone “A”.

In a zone “B” in FIG. 9, the LU-area is ON-area (YES at step A1); in D-range, since revolution speeds of Nt and Ne are increased, the shift control start conditions are satisfied (YES at step A2); and the LU specified pressure is 0 (NO at step A3, YES at step A11). The LU flag is set to LU inhibition (step A12), and the lock-up control is performed under a state of LU inhibition (step A1 3). In a zone “C1” in FIG. 9, the control is identical to that in the zone “B”. Contrarily, in a comparative case based on the related art, in zones “B” and “C1” in FIG. 9, the LU-area switches from OFF-area to ON-area. Therefore, the LU flag is set to LU permission, and the LU specified pressure performs pre-charge operation. Immediately after the engagement operation of the lock-up clutch, the lock-up is released. Thus, the torque changes greatly and the drivability is reduced.

In a zone “C2” in FIG. 9, the LU-area is OFF-area (NO at step Al); in D-range, the shift control is in shifting (YES at step A10); and the LU specified pressure is 0 (YES at step A11). Therefore, the LU flag is set to LU inhibition (step A12), and the lock-up control is performed under a state of LU inhibition (step A13).

In a zone “E” in FIG. 9, the LU-area is ON-area (YES at step A1); since immediately after the shift, the shift control start conditions are not satisfied (NO at step A2); the LU-area switches once and is non-busy (YES at step A4); since revolution speeds of Nt and Ne increase, No is also increased and the absolute value of a difference between previous value and current value of No exceeds a predetermined value (YES at step A6); and since Nt and Ne exceeds the predetermined revolution speed, the revolution speed is determined as satisfied (YES at step A7). Therefore, the LU flag is set to LU permission (step A8), and the LU specified pressure performs pre-charge operation.

According to the exemplary embodiment 1, when there is a possibility that the LU-area switches to OFF-area during engagement operation, the lock-up clutch is inhibited from starting the engagement operation. Therefore, since there is no chance of the lock-up clutch to engage during the engagement operation, the fluctuation of the output torque is eliminated, and thus, the drivability is prevented from reducing (refer to cases 1 and 2).

Also, the lock-up clutch is prevented from being released during the engagement operation. Therefore, at a point when the lock-up clutch comes into “piston touch” (partial clutch engagement start) during the engagement operation, the lock-up clutch is prevented from being released under a state that the output torque is fluctuating. Therefore, the fluctuation of the output torque is eliminated, and thus the drivability is prevented from being reduced (refer to case 3). Further, even when the LU-area switches from ON-area to OFF-area immediately after engagement, when Ne and Nt exceed a predetermined revolution speed, the lock-up clutch is prevented from being released. Thereby, the lock-up clutch is prevented from being released immediately after the engagement. Therefore, the fluctuation of the output torque is eliminated, and thus the drivability is prevented from being reduced. Furthermore, when Ne and Nt are less than a predetermined revolution speed, the lock-up clutch is inhibited from being engaged irrespective of the LU-area and engagement state of the lock-up clutch; and thus the engine is prevented from stalling.

Furthermore, when the LU-area switches to ON-area immediately before the shift operation, the lock-up clutch is inhibited from locking up. Therefore, the lock-up clutch is prevented from being released immediately after the engagement. Therefore, the fluctuation of the output torque is eliminated, and thus the drivability is prevented from being reduced (refer to case 4). Also, the shift shock due to the difference (high/low) of the lock-up pressure is prevented from fluctuating. Further, since the lock-up clutch is not allowed to slip during shifting, the durability of the friction material on the lock-up clutch is increased.

When the next shift control starts during an engagement operation, and at the same time when the shift starts, the LU-area switches to OFF-area, the lock-up clutch is inhibited from starting the engagement. Therefore, there is no chance of the lock-up clutch to engage. Therefore, since the lock-up clutch and the frictional engagement element on the transmission are prevented from being engaged simultaneously, booming noises and vibrations are not generated during the shifting operation (refer to case 5).

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

1. A lock-up clutch control unit for controlling a lock-up clutch mechanism provided in a torque converter, wherein
the lock-up control unit inhibits the lock-up clutch mechanism from starting an engagement operation when a zone based on a lock-up operation area map relevant to the lock-up clutch mechanism is switched from OFF-area through ON-area and again to OFF-area in a predetermined period of time in accordance to vehicle conditions.

2. A lock-up clutch control unit for controlling a lock-up clutch mechanism provided in a torque converter, wherein
the lock-up control unit inhibits the lock-up clutch mechanism from disengaging during an engagement operation, when the lock-up clutch mechanism is in a course of performing the engagement operation.

3. A lock-up clutch control unit for controlling a lock-up clutch mechanism provided in a torque converter, wherein
the lock-up clutch control unit carries out such a control action immediately after engagement has been established as to inhibit the lock-up clutch mechanism from disengaging during an engagement operation in case the engine speed and the input shaft speed of an automatic transmission are higher than a predetermined speed, even when a zone based on a lock-up operation area map relevant to the lock-up clutch mechanism is switched from ON-area to OFF-area in accordance to vehicle conditions.

4. A lock-up clutch control unit for controlling a lock-up clutch mechanism provided in a torque converter, wherein
the lock-up control unit inhibits the lock-up clutch mechanism from engaging regardless of which zone is selected according to the lock-up operation area map relevant to the lock-up clutch mechanism and regardless of whether the lock-up clutch mechanism is engaged or not, when the engine speed and the input shaft speed of the automatic transmission are lower than a predetermined speed.

5. A lock-up clutch control unit for controlling a lock-up clutch mechanism provided in a torque converter, wherein
the lock-up control unit inhibits the lock-up clutch mechanism from starting an engagement operation, when a zone based on a lock-up operation area map relevant to the lock-up clutch mechanism is switched from OFF-area to ON-area in accordance with vehicle conditions, immediately before shifting.

6. A lock-up clutch control unit for controlling a lock-up clutch mechanism provided in a torque converter, wherein
the lock-up control unit inhibits the lock-up clutch mechanism from starting an engagement operation, when a shifting operation starts immediately after the zone based on a lock-up operation area map relevant to the lock-up clutch mechanism is switched from OFF-area to ON-area, in accordance with vehicle conditions.

7. The lock-up clutch control unit according to claim 1, wherein
the lock-up control unit inhibits the lock-up clutch mechanism from disengaging during an engagement operation, when the lock-up clutch mechanism is in a course of performing the engagement operation.

8. The lock-up clutch control unit according to claim 1, wherein
the lock-up clutch control unit carries out such a control action immediately after engagement has been established as to inhibit the lock-up clutch mechanism from disengaging during an engagement operation in case the engine speed and the input shaft speed of an automatic transmission are higher than a predetermined speed, even when a zone based on a lock-up operation area map relevant to the lock-up clutch mechanism is switched from ON-area to OFF-area in accordance to vehicle condition.

9. The lock-up clutch control unit according to claim 1, wherein
the lock-up control unit inhibits the lock-up clutch mechanism from engaging regardless of which zone is selected according to the lock-up operation area map relevant to the lock-up clutch mechanism and regardless of whether the lock-up clutch mechanism is engaged or not, when the engine speed and the input shaft speed of the automatic transmission are lower than a predetermined speed.

10. The lock-up clutch control unit according to claim 1, wherein
the lock-up control unit inhibits the lock-up clutch mechanism from starting an engagement operation, when a zone based on a lock-up operation area map relevant to the lock-up clutch mechanism is switched from OFF-area to ON-area in accordance with vehicle conditions, immediately before shifting.

11. The lock-up clutch control unit according to claim 1, wherein.
the lock-up control unit inhibits the lock-up clutch mechanism from starting an engagement operation, when a shifting operation starts immediately after the zone based on a lock-up operation area map relevant to the lock-up clutch mechanism is switched from OFF-area to ON-area, in accordance with vehicle conditions.
